(19) United States
(12) Patent Application Publication
(10) Pub. No.: US 2005/0177613 A1
(43) Pub. Date: Aug. 11, 2005

(54) Statistical and vouyeristic link behavioral tracking and presentation tools

(76) Inventor: Scott Dresden, Delray Beach, FL (US)

Correspondence Address: TIGHE PATTON ARMSTRONG TEASDALE PLLC;PATENTS, P. O. BOX 27519, WASHINGTON, DC, 20038-7519, US

(21) Appl. No.: 10/776,689

(22) Filed: Feb. 11, 2004

(51) Int. Cl. G06F 15/16

(52) U.S. Cl. 709/200

(57) ABSTRACT

The present invention teaches a system for “snooping” on an Internet user's, or group of users' linking behavior though a web site or related pages, and statistically compiling such information, such that it is useful for presentation as the typical or average consumer or surfer experience on that site. Various embodiments of the invention allow for the system to record temporal and spatial aspects of the experience for a target group (by income, age, surfing behavior, condition precedent, etc.) of users and to specifically identify weak links or otherwise undesired behavior from surfers by finding specific statistical deviations. The identifiable strengths and weakness of a site can be identified and presented as executive summaries in a “simulated surfing” presentation format.

### BACKGROUND

Flaws in the design of a commercial website can cost an ecommerce entities millions of dollars a day in lost revenue. Missing or broken links, poor mouse ergomics, deep embedding of popular pages, inadequate search tools, mislabeled links, bad displays, confusing symbols all can reduced efficiency in site visitor behavior and lead to lost profits. A new type of computer, software and statistical/mechanical engineering has responded to these commercially important issues, known as “usability engineering.” Several usability engineering groups have achieved near-celebrity status due to the exponential growth and importance of ecommerce. The Neilsen/Norman group of Cupertino, Calif. have published several texts fundamental to site designed and managers, include certain texts which are incorporated by reference are Usability Engineering (1994), Designing Web Usability: The Practice of Simplicity (1999), and Homepage Usability: 50 Homepage Deconstructed (2001). FIG. 1 shows a representation of site testing. Such testing involves the manual or automatic recording of model users.

The VISVIP (created by the National Institute for Standards and Technology (“NIST”) allows a viewer to graphical view some aspect of represented flows through site pages. FIG. 2 is a diagram of the VISVIP program as implemented and taught by the text Web Metrics: Proven Methods for Measuring Web Site Success by Jim Sterne (John Wiley & Sons; 2002), which is incorporated by reference. VISVIP is a powerful tool for a usability engineer in desgining a Internet site. Webtrends® is another software product offered which allows for the measurement of website usability and efficiency. Another useful text is Modeling the Internet and the Web: Probabilistic Methods and Algorithms, by Badio, Fasconi and Smyth (2003), which is incorporated herein by reference.

However, as can be appreciated, often the decision makers need an “executive summary” that cannot be adquately gleaned from the above-referenced prior art. The site visitor experience either in partial or in the aggregate may also provide researchers and decision makers with important information unavailble from the above-reference prior art.

### SUMMARY

The present invention helps to improve website design and economy by conveying infromation to decision makes by providing a simulation of a singular or aggregate site visitors' experience. The experience can be conveyed through a web browser simulator that included many features for assisting in identifying any target problem and difference between visitors based on characterisics such as demographics, behavior on the site and time spent between each decision making process. The invention has the ability to covey decision points in the web users expericences that have accumulated disparate results potentially identifying problems in the site or critical points.

### BRIEF DESCRIPTION OF THE DRAWINGS

FIG. 1 shows a sample system for testing an ecommerce website;

FIG. 2 shows a representation of the prior art VISVIP®;

FIGS. 3A-C show the artictecture of a sample ecommerce website at multiple levels;

FIG. 4A illustrates an overview for the placement of the invention;

FIG. 4B is a closeup of the components of the invention;

FIGS. 5A-D illustrate components of the invention as they may be used in recording and indexing visitor behavior;

FIG. 6 is a representative time line with temportal characteristics used in the present invention;

FIGS. 7A-7C illustrates a sample interstitial process in which information is collected when a user requests content;

FIG. 7D represents the time representation of FIGS. 7B and 7C;

FIGS. 8A and 8B are same representations of data as may be represented in the present invention;

FIG. 9A-9D is a sample of visitation behavior as may be represented in the present invention;

FIG. 9E is the timeline representation of the visitation behavior in FIGS. 9A-90;

FIG. 9F is data representation of the visitation behavior in FIGS. 9A-9D;

FIGS. 10A-H is a representative series of setup and simulated webshow screens in the behavior tracking embodiment of the invention.

FIG. 11A-11B illustrate the sample control setup for the webshow display for a behavioral embodiment of the invention.

FIG. 11C shows a behavior setup method for the present invention.

FIG. 11D illustrates the results of a setup method;

FIGS. 12A-C show the statistically relevant highlighting feature of the present invention;

FIGS. 13A-C illustrate a sample control setup for the webshow display for a demographic embodiment of the invention;

FIGS. 14A-D are simulated webshow screens representative of a demographic webshow display;

FIG. 15 illustrates the sample control setup for the webshow display for a time frame embodiment;

FIG. 16 representation a timeline and computation table for presenting the webshow display in a time frame mode;

FIGS. 17A-B illustrate the split screen feature in an alternate embodiment of the present invention;

FIGS. 18A and B illustrate two setup screens for eavesdrop mode;

FIG. 19 illustrates sample of the setup and simulated webshow process in recordable eavesdrop feature in the present invention with target and random modes;

FIG. 20A illustrates a live eavesdrop mode selection screen;

FIG. 20B illustrates a sample simulated browser for live eavesdrop;

FIG. 20C illustrates a terminal event notification screen;

FIG. 21A illustrates a statistically updated embodiment of the browser simulation;

FIG. 21B illustrates a statistically updated embodiment (relative) with event split screen thresholds.

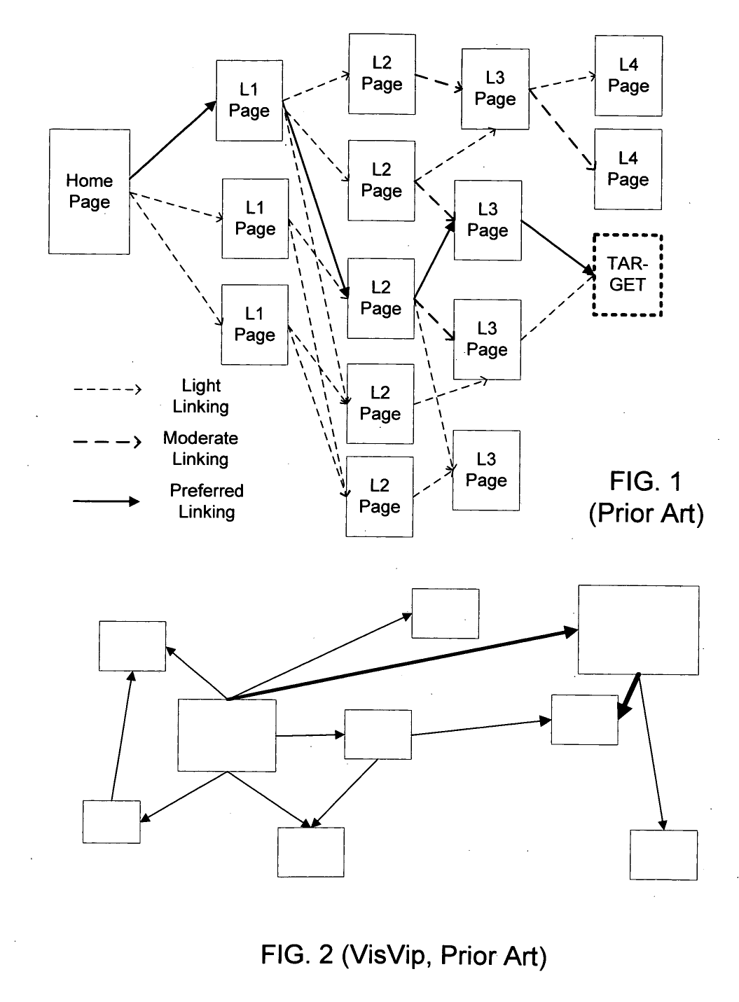

### DETAILED DESCRIPTION OF THE DRAWINGS

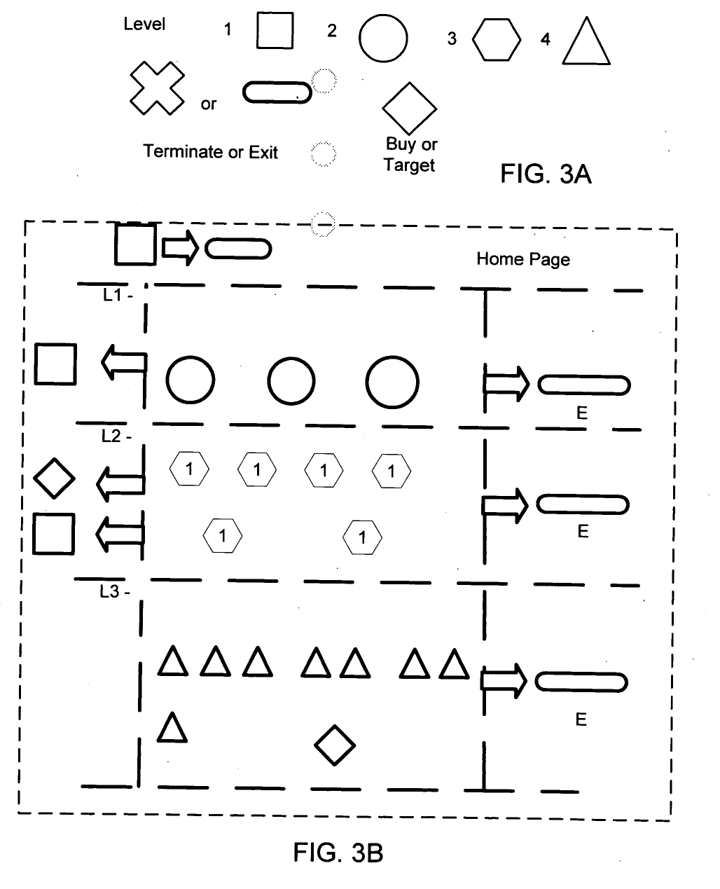

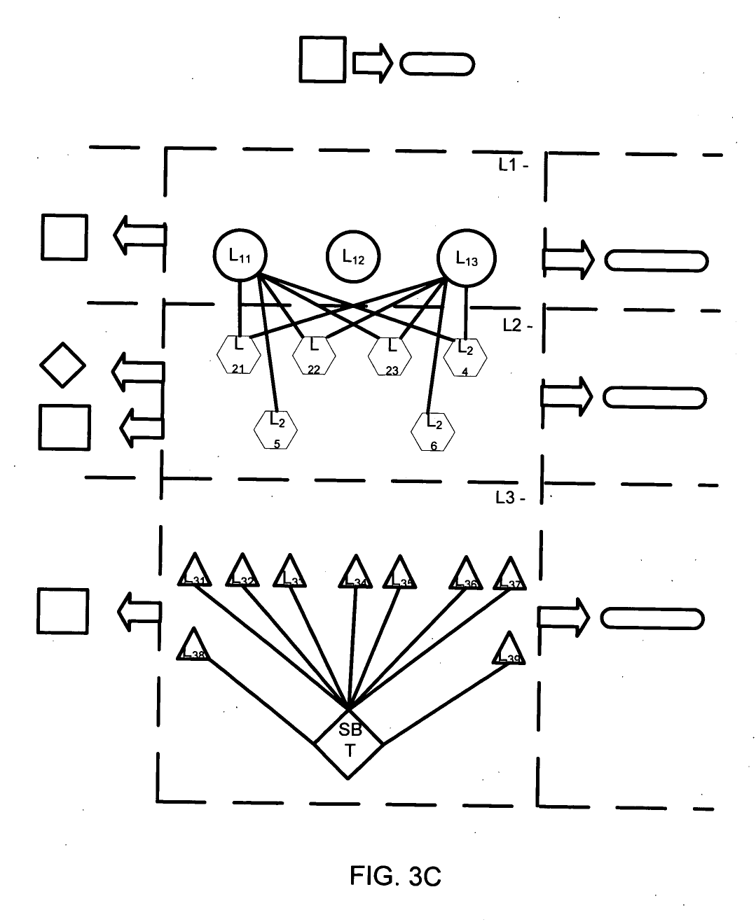

Referring now to FIGS. 3A and 3B, a representative architecture of an ecommerce Internet site is shown. The key to website “items” is located in 3A for illustrative purposes. FIG. 3B is a representative example of a commercial (or portion thereof) website with a highly simplified structure. The site has multiple levels or depths indicated by pages with 4 different shapes, H (the home page), L1, with 3 pages (circles), L2, with 6 pages (hexagons), and L3 with 10 pages (triangles). The square is the home page or portal page, which also may be indicated by a “little house” symbol. The long oval E, is an exit scenario, either by a specialty instruction S(x) or link indicated by a diamond. These structures may include all sorts of items like help, Amazon® one-click, check shopping cart, etc. The jump link is indicated by a special sized or clear fill arrow.

Referring now to FIG. 3C, a “link diagram” between the levels L1 and L2 and interlinks of L3. The links between L2 and L3 are not shown. The L3 pages are all connect to a specialty button SB that may be a target of an ecommerce site or an informational site, such as a sale or a click through target.

As can be appreciated by the skilled artisan, FIGS. 3B and C represent “levels” in an organized schematic, but as these pages are virtual and linked electronically, there is no requirement that there be levels per se, except that such a construction helps to illustrate the invention from an organizational concept. The individiual pages and links present an opportunity to implement the invention or record or track a “target event.”

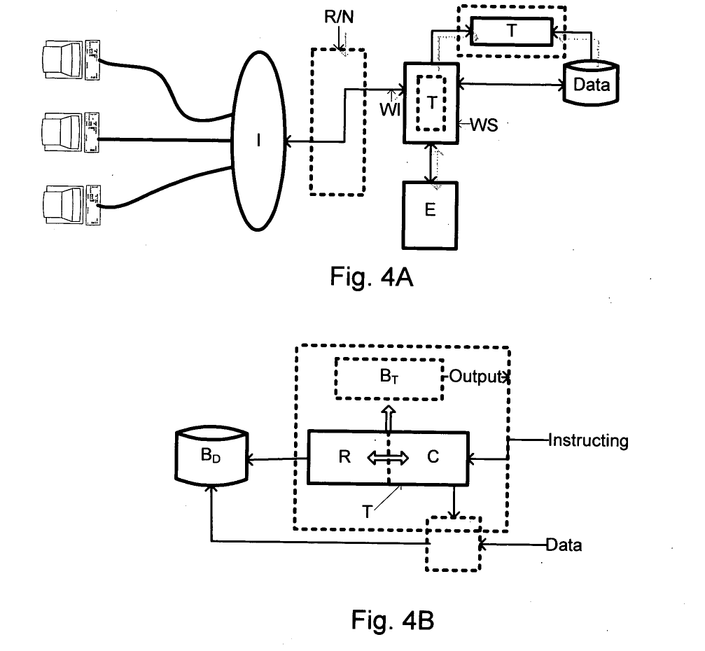

Referring now to FIGS. 4A and 4B a sample system for implementing the invention is illustrated. FIG. 4A shows a sample ecommerce structure with a web server (WS) an Ecommerce engine (E), and Content Data storage (D). The invention may be implemented virtually by remote connection, but in a preferred embodiment is run with a software module on the web server, or with a module connected to the web interface (WI). A separate retrieval and computation module (T) may be embodied in hardware separate from the web server (WS). Ideally, the invention will be implemented in modules that maximize tracking and data storage capability. The computation module does not need to be physically present at any particular location. For example, the preesnt invention may be implemented in a subscription service or even a single use service. Please see U.S. Published application Ser. No. 09/833,236, Publication No. 2003403331, Feb. 13, 2003 entitled INTEGRATING MEDIA FILES by Sena et. al. This publication is incorporated by reference for particular aspects of remote or subscription computing in relation to multimedia presentation to a user and the translation of certain multimedia software into a universal presentation system accessible by multiple users. The present invention may also be implemented in “off the shelf” software formats.

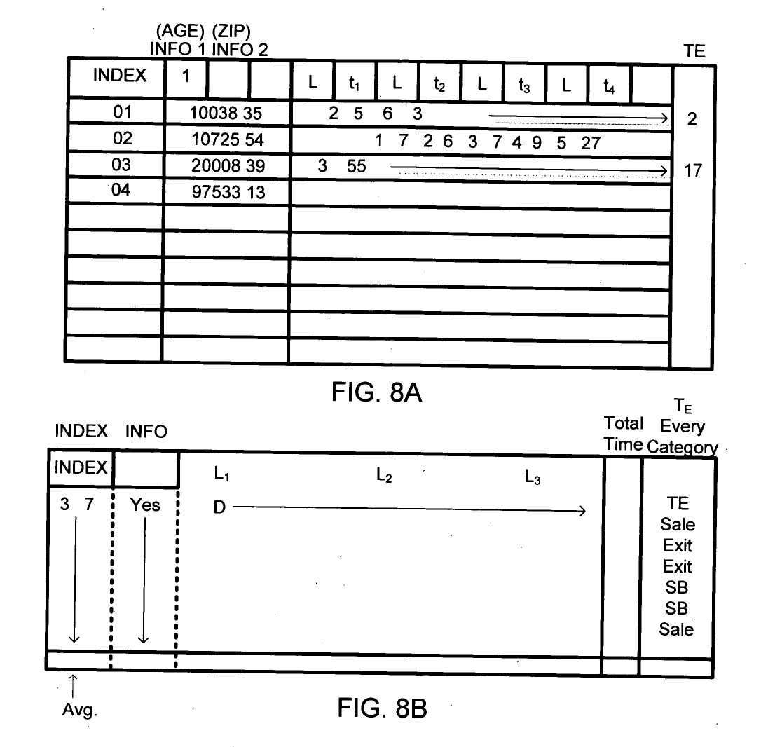

Referring now to FIG. 4B a more detailed functional aspect of the invention is shown. The retrieval and computation unit may be virtually implemented into the data retrieval (R) and computation (C) units which must communication with each other directly or virtually. The retrieval module (R) must be able to access user behavior data compiled and stored on storage unit sS. Perferable the data is stored in a universally recognized or indexed format, but embodiments of the invention that are implemented with the ecommerce sites may performed this function as well as control the data storage, limiting the need for massive data storage and providing a pre-screening and cataloging function for the behavioral data (see FIGS. 8A and 8B, below) for economical retrieval and compilations. The computation unit C recieves instructions for data compilation and criteria. As mentioned above the computation unit may also screen incoming data with a virtual screening unit (SCR), that limits the data recorded and optionally provides indexing and cross-referencing. For the output an optional browser translation unit BT may allow users of the invention to monitor the website beahvior remotely or other variations by providing simulated browser experience in multiple formats.

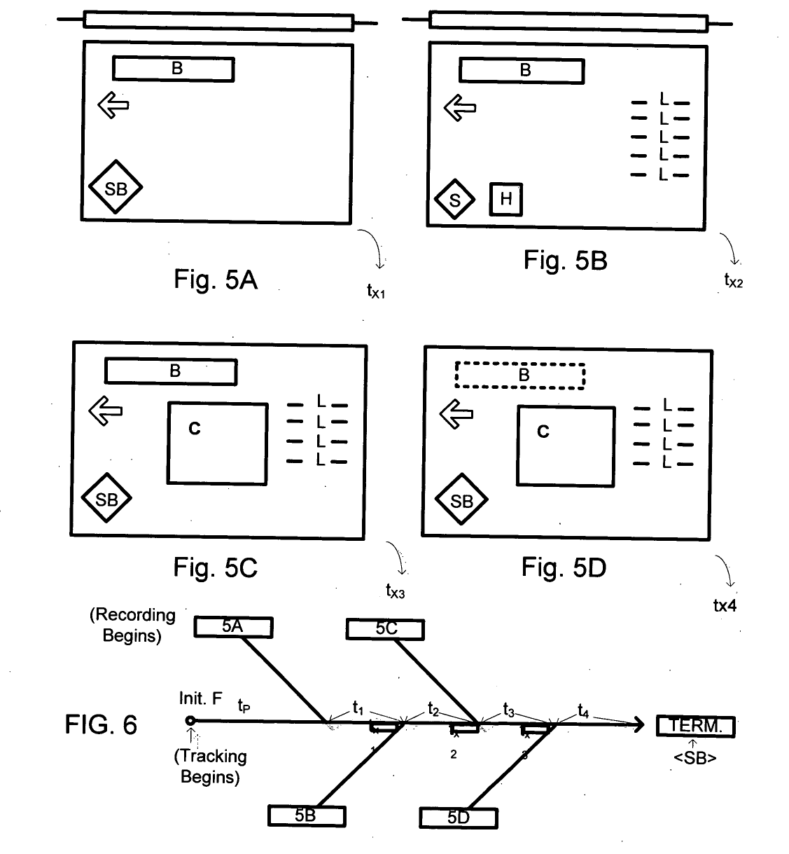

Referring now to FIG. 5A-5D a sample behavior of 4 subsequent screens represents user linking behavior in a sample visit to the website. In FIG. 5A, the user is located at L1, and points to a link (indicated by the arrow). Clicking on'the link brings up the screen/page shown in FIG. 5B in the time indicated by t(x1). The user then click on the link shown by the arrow which brings up the screen/page shown by FIG. 5C in time t(x2), at which point the user clicks on the “back arrow” (on the page as opposed to the users browser back button) which brings up the screen shown in FIG. 5D, which is also the screen shown in 5B, in time t(x3). At this point, the user clicks on speciality button SB, which for illustration purposes is a terminating event. FIGS. 5E and 5F illustrate alternate ending page events, one with an exit button (oval) and the other with a browser exit (not shown) which is executed by the user by typing in an web address or closing the browser window.

Referring now to FIG. 6, a representative time lines and recordable event trackers that are recorded by the data gathering module in the invention. FIG. 6 indicates that there are 5 representative times t(p)-t(4), which may include page load times t(x1), t(x2) and t(x3) and that are matched to the screens shown in FIGS. 5A-5D, respectively. In FIG. 6, time T(0) may also be an initiating or recording event which in this case is the loading of the page shown in FIG. 5A. In other circumstances the initiating event will be defined by the user in the setup software of the present invention. Any initiating event may be a subset of site visit behavior of interest such as clicking on a particular link, or a specialty button S(x), which allows the tracker to identify particular behavioral traits that may be troubling the ecommerce site. Time t(p) is the time to the first link page load shown in FIG. 5A, time t(1) is the time to the link shown to the page load shown in FIG. 5B. This time may include the load time for the page shown t(x1) in FIG. 5B as a subset. But the load times may be alternately configured in other embodiments. Time t(2) is the time spent on the page in FIG. 5B, t(3) is the time spent on the page shown in FIG. 5C and t(4) is the time spent on the page shown in FIG. 5D until the terminating event T(e) takes place. The terminating event T(e) may define as any one event, a combination of events, or any one of a set of events. The present illustration shows the terminating event T(e) as clicking the specialty button SB.

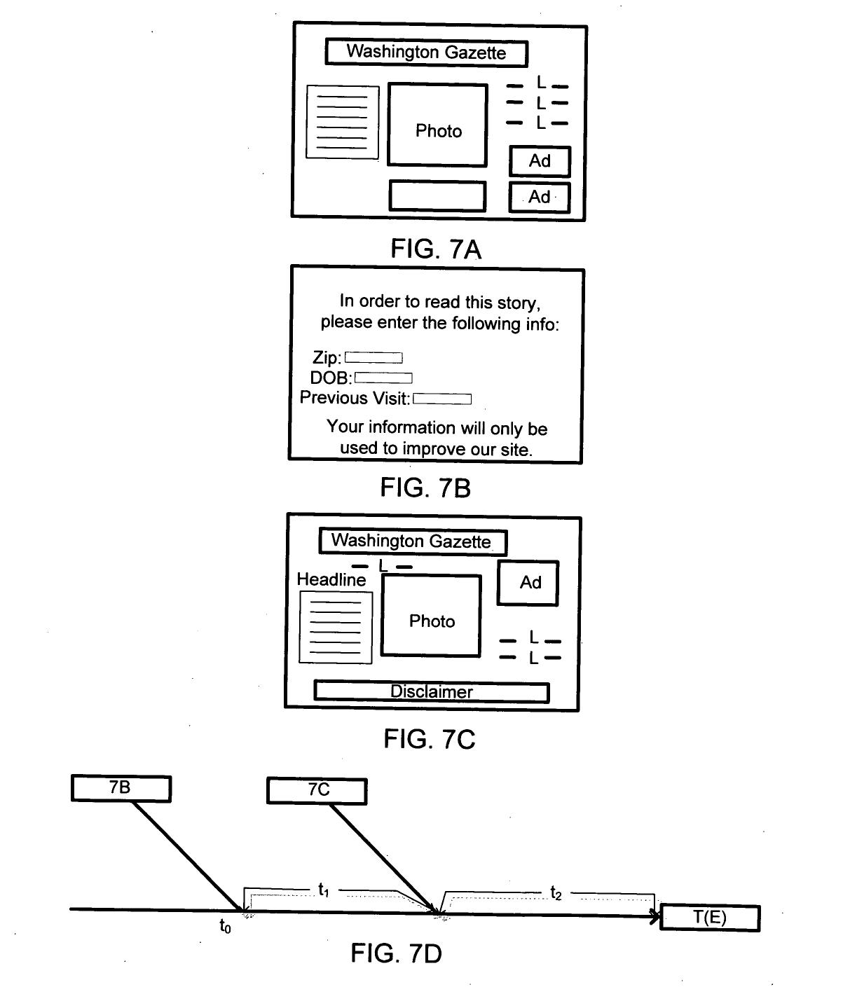

Referring now to FIGS. 7A-7C a sample of an existing webscreen as it would be used to collect information from a user, who may have been indexed upon entering the site or a particular page. The user enters the page shown in FIG. 7A and upon clicking a story link or photo for content is present with an information entry screen shown in FIG. 7B. This may be optional for certain content sites, but also may restrict information to visitors who do not enter certain demographic information. The user, if successful in meeting the criteria for continuing, which may not be needed in some embodiments of the invention, is given content screen shown in FIG. 7C. The recording event is the first content screen and is shown in the FIG. 7D timeline.

FIG. 8A illustrates a sample representative data table that may be compiled in statistical format the entry as shown from FIG. 6 and FIG. 7B. As can be appreciated by those skilled in the art there may be various preferences for selection among the statistical sampling of the accumulated data of the site Visit behavior. FIG. 8B is another example of representative data that may be compiled in the present invention. This data is then used for compilation in the presentation format.

Of course, there are some statisitical features that result in disparate results, and as can be appreciated by the skilled artisan by reference to many of the texts and materials mentioned in the background that a statistical compilation may be incomplete description of the data. For example, a small percentage of users may actually make it to a desired event like a “sale” or specialty button, such as Amazons® one-click purchase. Thus, the user-definable data features and tolerance parameters of the present invention must be considered carefully by implementors and administrators of embodiments of the invention. For example, if an administrator defines an initiating event T(0) as entering a home page and a terminating event T(e) as a purchase, without any other limiting criteria 99.4% percent of users may not be included in the statistical anomaly of a purchase, thus for the 0.6% the compiled data may accurately be representative of the “average experience.” However, for the above mentioned “disparate” statistics. If T(0) and T(e) are set too far apart or a junction, the “average experience” may be just barely so. For example on a page, a defined subset (included in the compiled and retrieved data) of users may include 49% exiting and 51% clicking on the various links (4 choices). Thus, given an equal chance of choosing the 4 links, there will be only 12½% chance of each link. Thus, out of the equal 5 choices the vast majority will exit and setting the parameters to such a tolerance will result in the web simulation of exit (and maybe thus a terminating event T(e)).

Therefore, the present invention includes advanced embodiments that allow for the pooling of a set of otherwise individual criteria to create a statistical snapshot of the simulated browser experience. For example the function for the above-referenced page could include a statistical pooling (Pool (link 1, link 2, link 3, link 4)) as a single statistical critera.

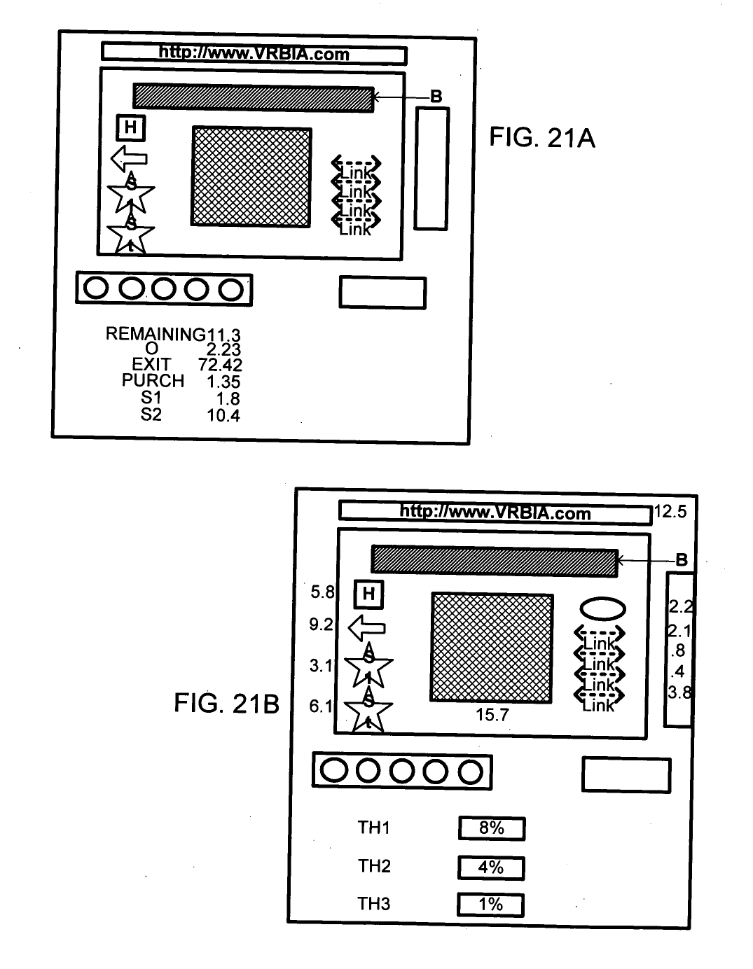

A more advanced feature of the invention is a dynamic statistical update at all selection points indicating what percentage of the original pool of users as defined statistically (demographic) or by a behavioral event, or multiple criteria are left at the selection and how may have gone a ceratin pathway. This is only in part discussed in the prior art by VISVIP. As can be appreciated by those skilled in the art, defining subsets of alternate pathways in a webshow simulation must be limited to a reasonable alternative number of possibilities to be useful. For example if T(0) and T(e) are disparate or distant, a running tab of the percentage of exits, back arrows, homes, revisits and stalls may be useful, but an unlimited number of each link may be provided by statistics or representative data, but may crowd the screen during the web simulation. This advanced feature is shown in FIG. 21A.

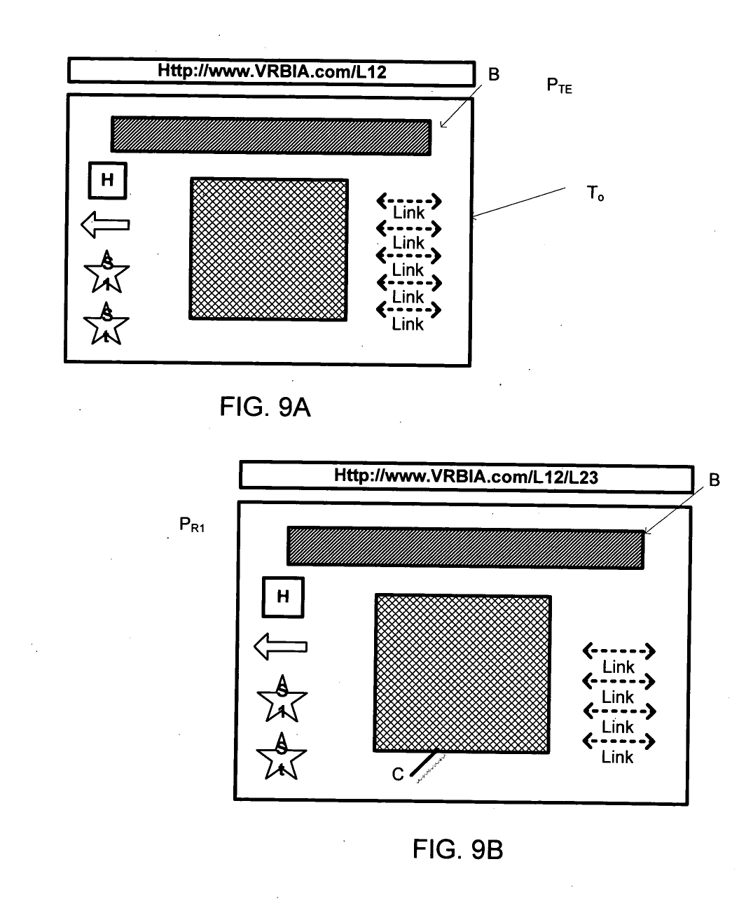

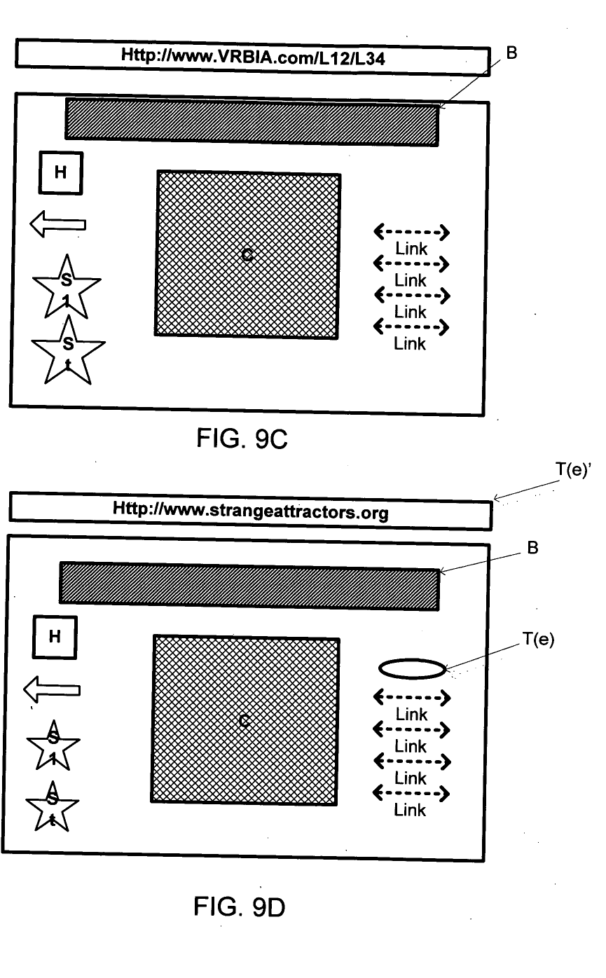

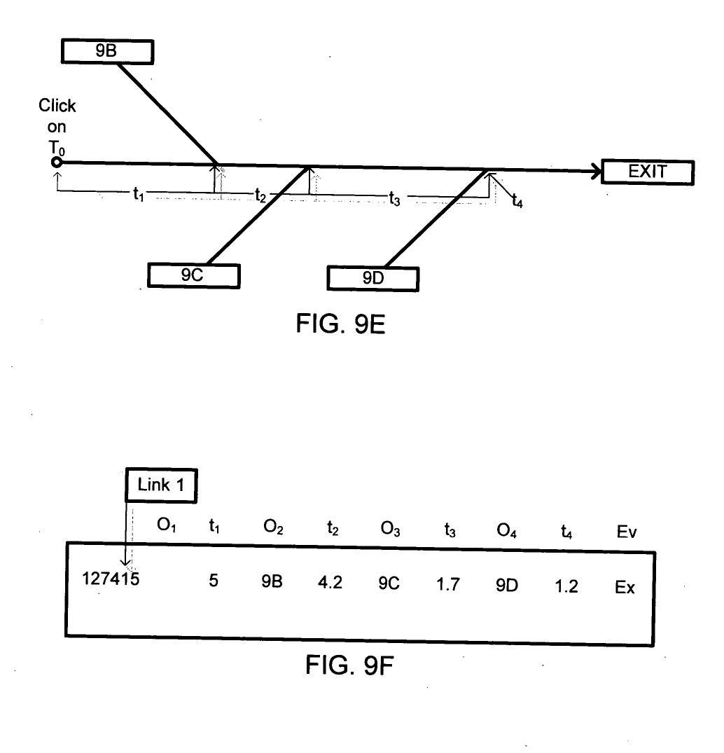

Referring now to FIGS. 9A-D, a data compilation scenario is translated for translation into statistical webshow based on a behavior characteristic in a preferred embodiment of the invention. FIG. 9A shows a target event page P(te) in which a particualr behavior of a site visitor will result in tracking information. In this illustration, the target behavior is clicking on link, mark as T(0) or an intiating event. Subsequently time and behavior is tracked for the users site visitation behavior in pages FIGS. 9B and 9C until the terminating event T(e) is detected on the page shown in FIG. 9D, by clicking the exit link or typing in a new url off the ecommerce site.

FIG. 9E represents the event scenario recording timeline indicated by the behavior shown in preferred embodiment behavior tracking. FIG. 9F is the resulting recorded data entry for the behavior represented in FIGS. 9A-D and 9E.

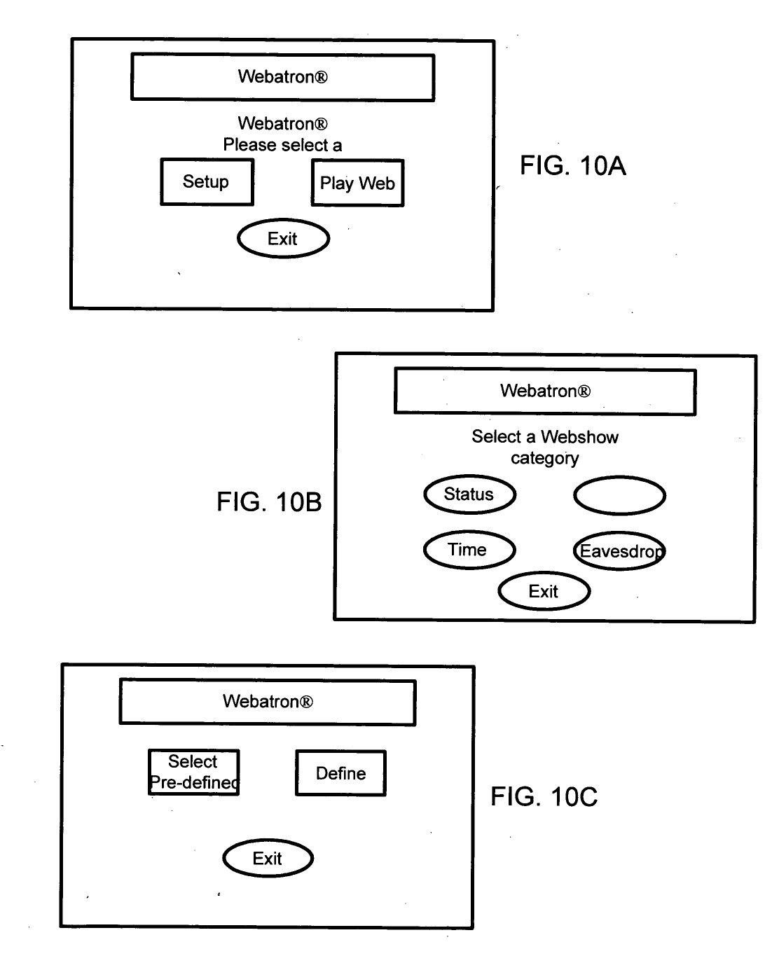

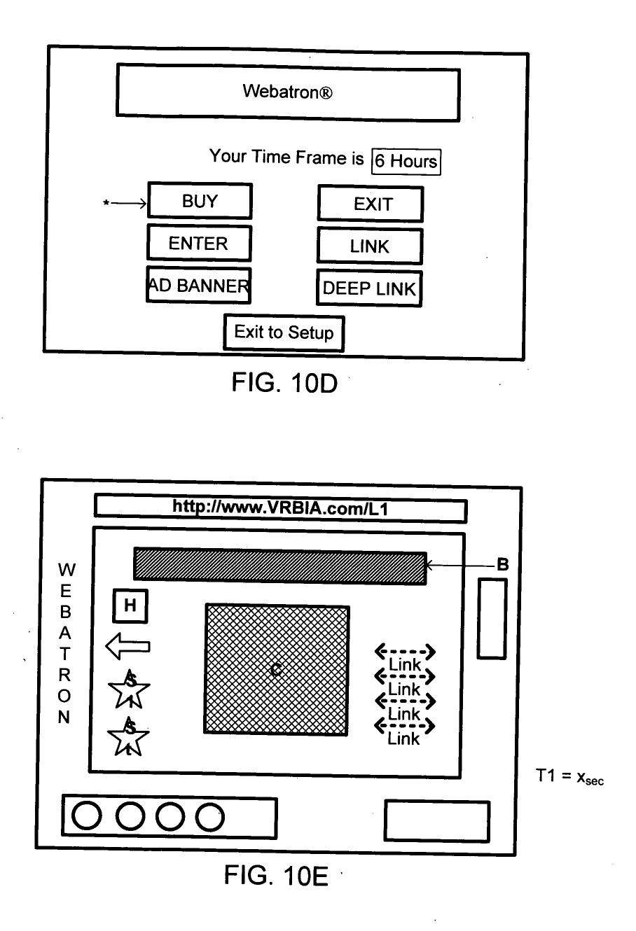

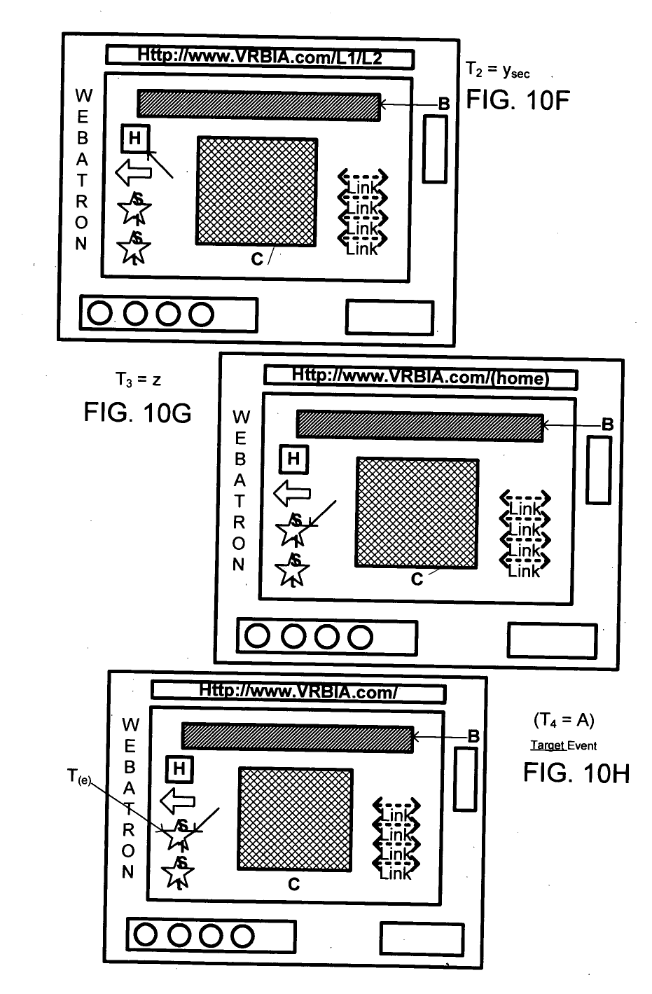

Referring now to FIGS. 10A-H eight representative screens of the present invention for a behavioral tracking in an implemented embodiment of the intvention. FIGS. 10A-D are the menu selections for choosing a pre-defined behavior webshow.

Referring now to FIGS. 10E-H a sample webshow as implemented in the present invention which statistically “simulates” the browser experience of the “identified visitor.” The identified visitor, for purposes of describing the invention is any number (including zero) of visitors' compiled information that qualifies in the criteria definition. FIGS. 10E-H represent 4 discrete screens along the continuous simualted browser experience, which may be experienced as continuous by the viewer.

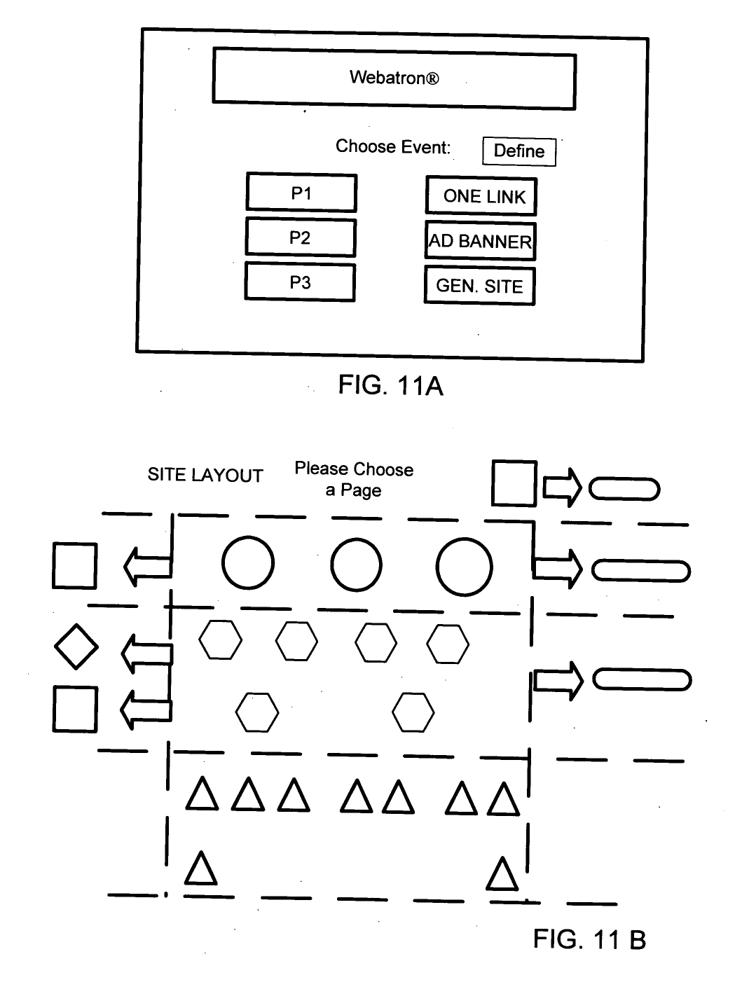

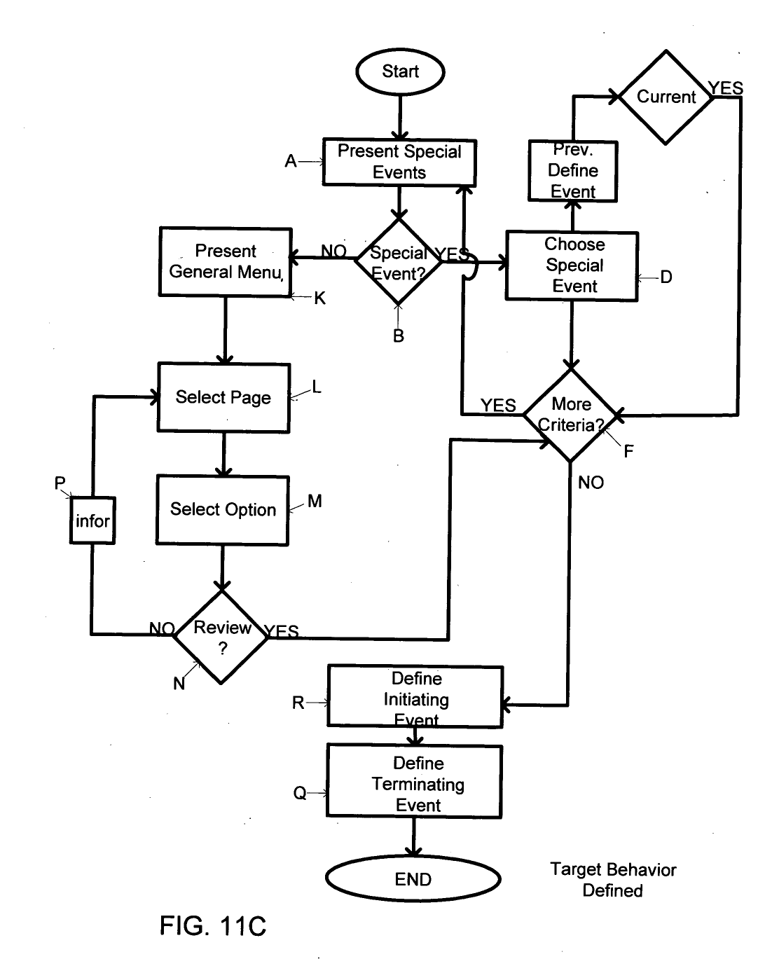

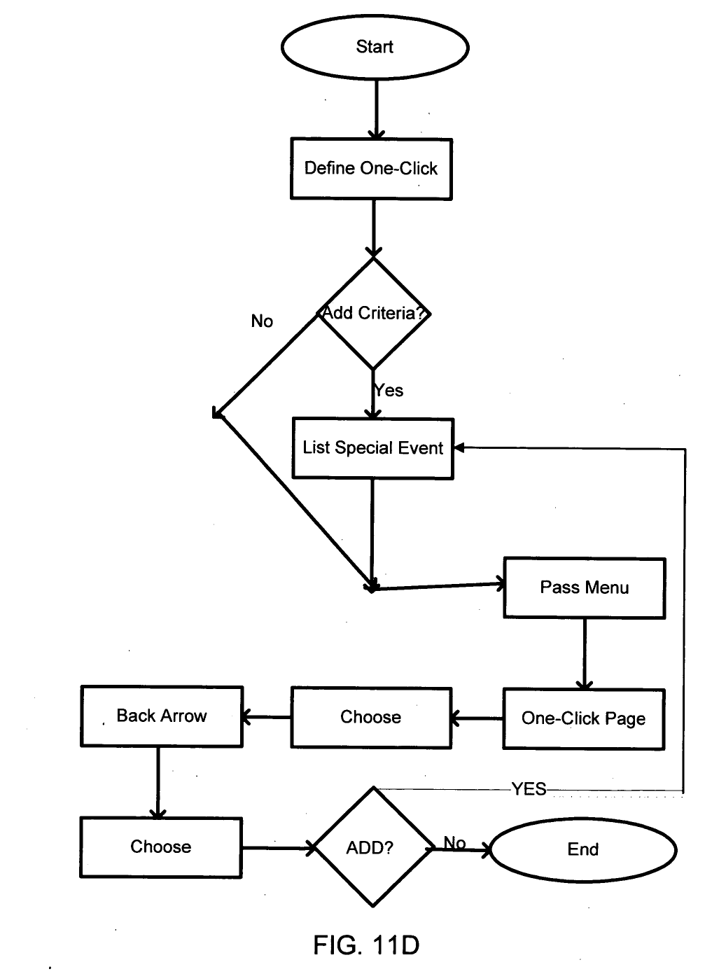

Referring now to FIGS. 11A-D, a definitional process as would be used in the present invention is shown. Sample setup screens include initial screen in FIG. 11A and general site event selection in FIG. 11B. A corresponding flow chart in FIG. 11C is shown. In Step A the main menu screen is loaded with pre-defined events (shown as P1, P2, P3, One-Clik, Ad bann) and general selection option in decision B. If a special event is chosen in Step D, a user is then asked if an additional behavioral criteria is needed in decision F. For example, for all users who use one clik and then back out of the page, two criteria are used (this is shown in FIG. 11D). If no additional criteria is need then the menu will proceed to processing to defining an Initiating recording event and a terminating event, steps R and Q, respectively.

If the general menu is selected in decision B, the general site layout is presented in step K, bringing up the menu screen represented by FIG. 11B. The user then selects a page (or link) in step L. The page is then presented with all available visitor options such as links, timing, specialty buttons, etc. and the user selects the available page options in Step M. The user is prompted to review this behavioral criteria in Decision N, which also is checked for viability. If it is not viable, the user is informed in step P and prompted to select a page from the menu in FIG. 11B. The user is then asked if more behavioral criteria is needed in decision F.

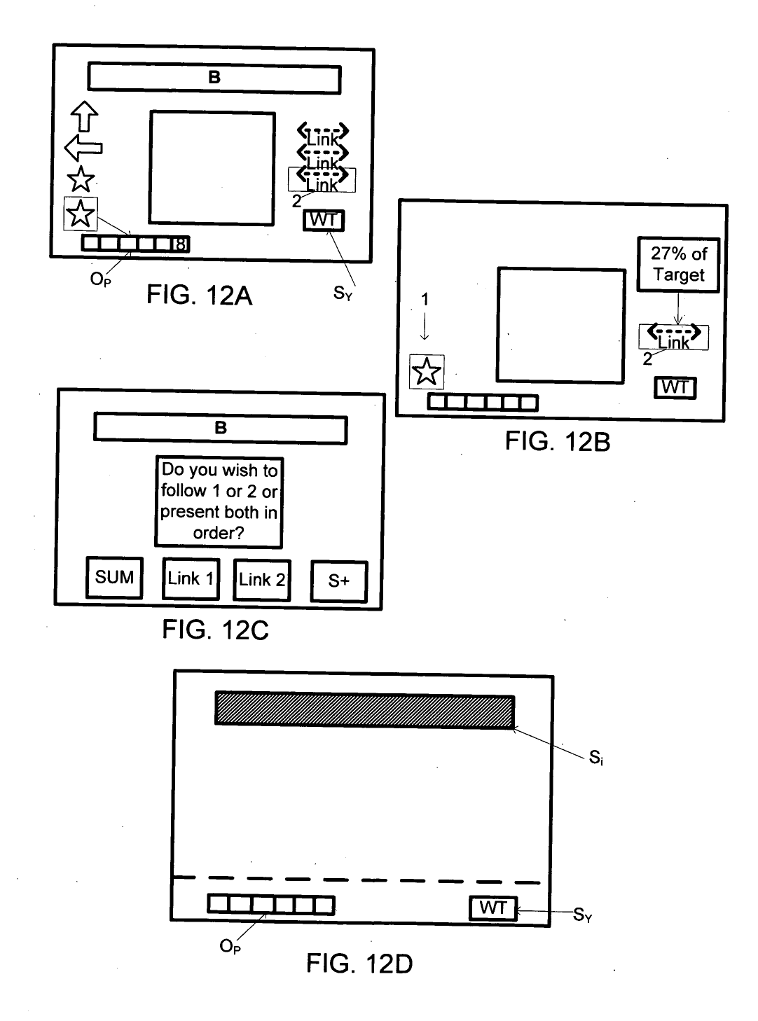

Referring now to FIGS. 12A-D, a highlighted feature presentation disparity in a webshow presentation.

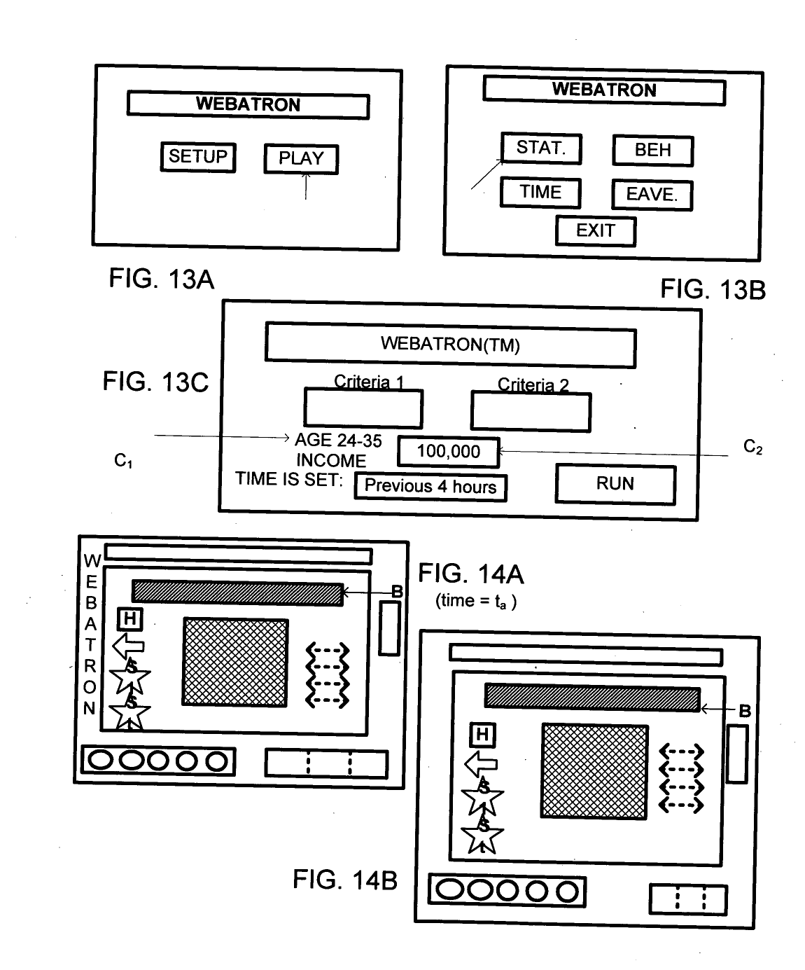

Referring now to FIGS. 13A-13C, a sample menu selection for the webshow statistical choice. FIGS. 13A and B are the same as FIGS. 8A and B except the user choose the statistical option in screen 13B. The criteria is chosen at FIG. 13C from available options, in this case “age: 25-34” C1 and income “100000+” as the second criteria. The time range is displayed for the benefit of the user.

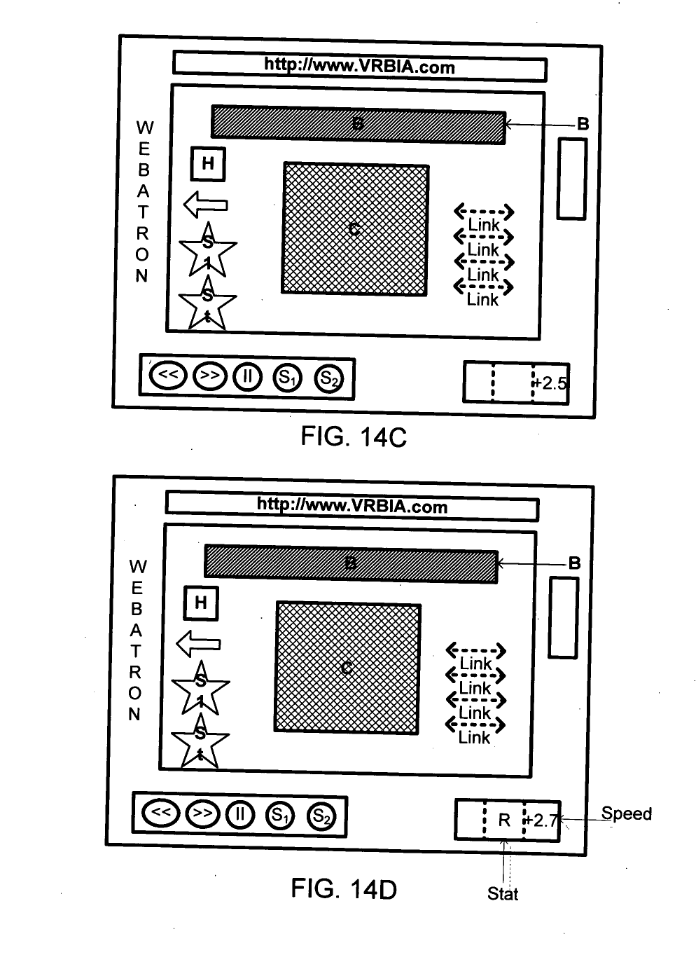

Referring now to FIGS. 14A-D, a resulting demographic statistical webshow simulates 4 sample screens in a simulated browser experience for the chosen demographics in FIG. 13C over the target time range. These screens are much like those discussed in FIGS. 10E-H above but are based on user characteristics if they are available.

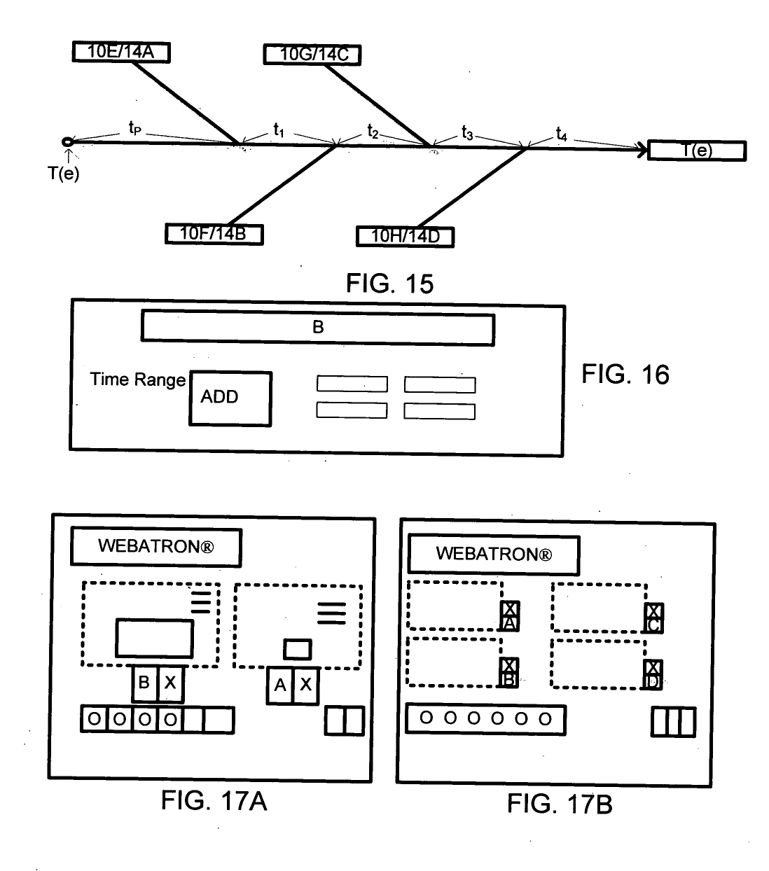

FIG. 15 shows the time elapse aspect as it applies to FIGS. 10E-H and FIGS. 14A-D in sample embodiment. As shown in the figures the invention has the optional embodiments in which the user can speed up, slow down, skip a sample action or stop the simulated browser at any point. The user is also presented with the real time multiplier to understand the real-time aspects of the visitor criteria.

FIG. 16 shows the time range criteria embodiment of the invention as would be entered into a sample control screen. The time criteria may be set to a setup default (last 4 hours, etc.) or will be used alone or in addition to any other available criteria of behavior and/or demographics. The time range may be relative or absolute as, can be appreciated by those skilled in the art.

FIG. 17A shows a split screen webshow device embodiment of the invention. The split screen statistical identifier is determined by thresholds set by the user of the WEBATRON® if they wish to identify a selected subset of visitor behavior among a sub target group that result in disparate behaviors that are discussed above and can be be understood from the back ground references. These statistical anomalies are discussed above with regard to FIGS. 8A and 8B and is shown in FIG. 21B as defined thresholds TH1, TH2 and TH3 (8, 4 and 1 percent respectively). In this case, if any more than 8 percent of the users perform an alternate event at any one decision point such as a page full of links, (other than the statisical average or majority) the screen will split and allow the viewer to compare the two sets of behavior. As shown by FIG. 17B the two screens may also be split again. The viewer may eliminate a screen without readjusting the threshold. As can be appreciated by those skilled in the art, the threshold levels to create the split screen scenario may be defined in term of absolutes (percentage of visitors from the initial event) or relatives (percentage of visitors remaining) statistically in the current page.

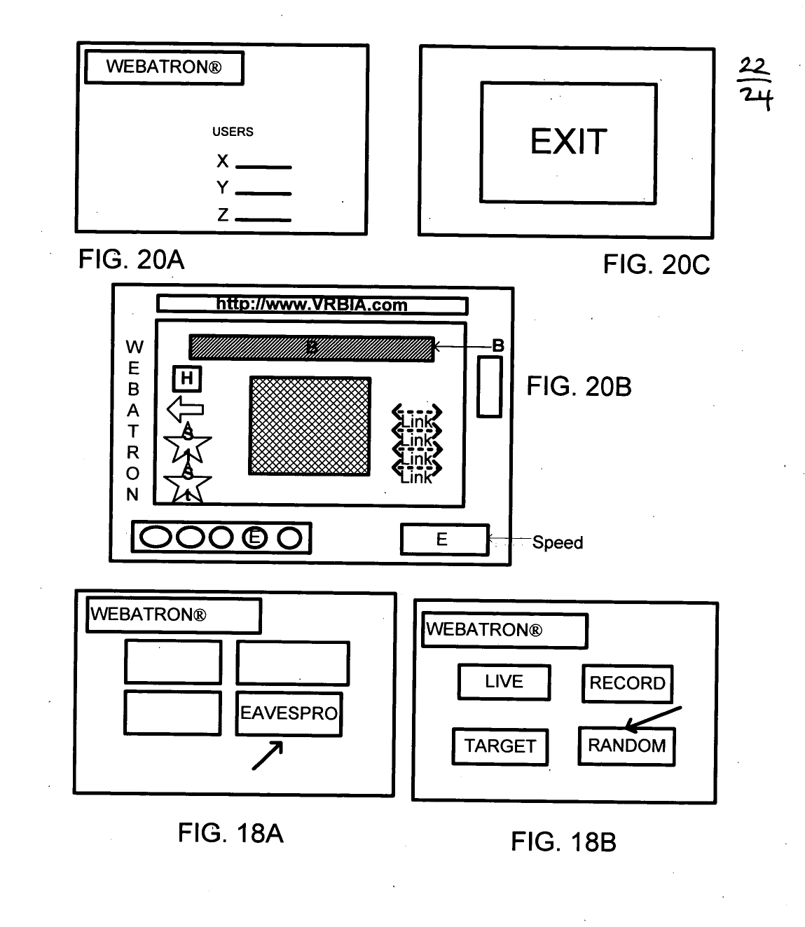

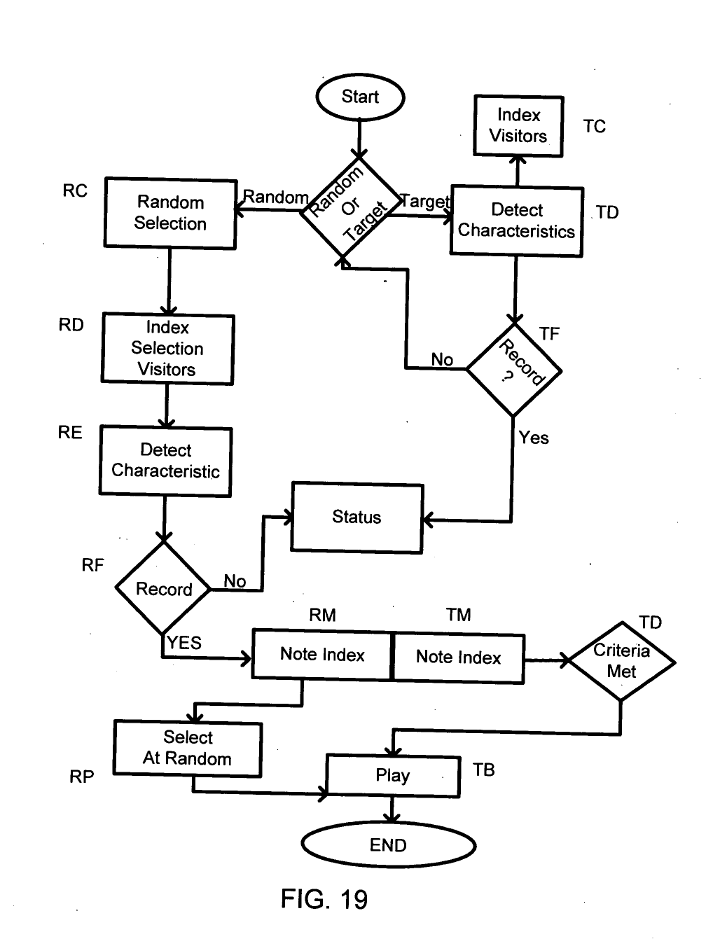

Referring now to FIGS. 18A and B, an eavesdropping embodiment of the invention is shown. FIGS. 18A and B represent the menu screens for choosing this feature which may allow for real time viewing (doppleganger mode) or specific or random recorded mode. For example, a particular visitor's behavior may be of interest to the researcher and have allowed cookies to be placed on the their computer so that they may be identified upon entering the site. FIG. 19 shows a sample flow chart for implementing this eavesdropping mode in a recorded version. The target identifier can be indexed at step TD if certain desired criteria are met. The recordable criteria decision at decision TF is similar to that discussed above of for the other three (and combinations thereof) selection embodiments. The random selection step RC uses an identifier from a random number to attempt to include visitors without preference to any type of profile. Thus steps RC (random selection), Rb index of random selection, RE characteristics of random selection and RF (recordation of visitation behavior) may be used in combination with any other feature or embodiment of the invention without departing from the scope and spirit of the invention.

FIG. 20A allows the user to select from among the active visitors that can FIG. 20B shows that the live (doppleganging) mode (which cannot be accelerated for obvious reasons). FIG. 20C shows a special notification screen upon a terminus or terminating event as described above.

1. A method for tracking and presenting information regarding the behavior of a plurality of users on a series of web pages, include the acts of:
displaying an initial content menu screen;
prompting a content user for statistical information when said content user chooses a desired link and storing said information on an electronic database;
returning to a first content screen including links to a plurality of content screens after said content user has successfully entered information;
recording said users' choices of links from first content screen as long as said users' choices are recordable;
replaying said recording of at least one of said users' choices in the perspective of said user in a browser simulator.

2. The method as recited in claim 1, further including the act of recording the time said user takes between each link.

3. The method as recited in claim 1, wherein said replaying step include replaying a plurality of users'.

4. The method as recited in claim 3, where said replaying stepsincludes selecting a criteria from said statistical information entered by said user.

5. A method for presenting a statistical amalgam of link visitation behavior, including the steps of:
indexing at least one site visitor;
detecting an activation event caused by said at least one visitor;
recording at least one action of said at least one visitor, said recording being stored in accessible electronic storage;
selecting an index criteria, said criteria based on a criteria action from said at least one recorded action;
recalling all stored actions from all indexed recorded data matching said index criteria;
statistically compiling said recalled stored actions;
presenting said statistically compiled actions into at least one browser simulation on a computation device.

6. The method of claim 5, wherein said indexing step includes said timing of said sub actions.

7. A system for studying the behavior of visitors to an Internet site including:
an indexing system for identifying at least one visitor;
a event initiation module for triggering the recording of the browser behavior of said at least one visitor;
an event termination module for terminating the recording of said browser behavior;
data storage coupled with said internet site;
a behavior organization module coupled with said data storage, capable of retrieving selected recordings from said at least one recording and compiling data representative of at least one visitor's browser behavior, wherein said behavior organization module uses at least one criteria to select; and
a browser simulator capable of taking data from said behavior organization module and presenting an accurate simulation of said compiled data.
